(19) United States
(12) Patent Application Publication
(10) Pub. No.: US 2025/0341460 A1
(43) Pub. Date: Nov. 6, 2025

(54) LIGHT-EMITTING DEVICE, LIGHT DETECTION DEVICE AND METHOD FOR OPTICAL ANALYSIS

(71) Applicant: MEGA CRYSTAL BIOTECHNOLOGY SINGAPORE PTE. LTD., Singapore (SG)

(72) Inventors: Yi-Sheng Ting, New Taipei City (TW); Kuo-Wei Hsu, Taoyuan City (TW); Mai-Chih Liu, Hsinchu City (TW)

(73) Assignee: MEGA CRYSTAL BIOTECHNOLOGY SINGAPORE PTE. LTD., Singapore (SG)

(21) Appl. No.: 19/196,752

(22) Filed: May 2, 2025

Related U.S. Application Data
(60) Provisional application No. 63/641,430, filed on May 2, 2024.

(51) Int. Cl. G01N 21/25; G01N 21/27

(52) U.S. Cl. CPC G01N 21/255; G01N 21/27; G01N 2201/022; G01N 2201/0612; G01N 2201/062

(57) ABSTRACT

The present invention proposes a light-emitting device and a light detection device which includes the light-emitting device. The light-emitting device includes a group of rays, a detector set to detect the group of rays, and a variable dimension space disposed between the rays and the detector set. The rays include a first beam of a first wavelength range and a first peak wavelength, and a second beam of a second wavelength range and a second peak wavelength different from the first peak wavelength. The variable dimension space disposed between the group of rays and the detector set and includes a first beam path of a first length for the first beam to pass through and a second beam path of a second length for the second beam to pass through. The first length is different from the second length.

### CROSS REFERENCE TO RELATED APPLICATIONS

This application claims the benefit of U.S. Provisional Application No. 63/641,430, filed on May 2, 2024. The content of the application is incorporated herein by reference.

### BACKGROUND OF THE INVENTION

### 1. Field of the Invention

The present invention relates to the technical field of transmissive optical analysis, and in particular to a light-emitting device, a light detection device which includes the light-emitting device and a method for optical analysis by using the light detection device to respectively obtain a first transmissive detection signal and a second transmissive detection signal respectively based on a first beam and the second beam passing through a variable dimension space to determine and adjust the transmissive intensity of the first detection signal and of the second detection signal.

### 2. Description of the Prior Art

At present, optical analyzers can be broadly categorized into single-beam spectrometers, double-beam spectrometers, dispersive spectrometers (such as prism-based or grating-based spectrometers), and Fourier transform spectrometers (such as FTIR spectrometers). In conventional single-beam spectrometers, the detection principle involves a light source emitting a probe light beam, which passes through a monochromator to select a specific wavelength before traveling through an absorption cell containing the sample under test.

The sample absorbs different wavelengths to varying degrees according to its composition, and the transmitted light, after passing through the sample, is received by a detector to obtain an absorption spectrum for analyzing the physical or chemical properties of the sample. Double-beam spectrometers, on the other hand, simultaneously measure a reference beam and a sample beam to enhance measurement stability and accuracy.

In dispersive spectrometers and Fourier transform spectrometers, the light is typically dispersed by optical components such as prisms or gratings, or processed via an interferometer before being detected spectrally. However, regardless of the type of optical analyzer, when the sample exhibits strong absorption characteristics, the transmitted intensity of the probe beam after passing through the absorption cell may be too weak to sufficiently outperform background noise, resulting in a poor signal-to-noise ratio (SNR). A low SNR significantly compromises the precision of spectral interpretation and quantitative analysis.

Therefore, there is an urgent need for an improved solution capable of achieving an acceptable signal-to-noise ratio even when analyzing samples with strong absorption spectra.

### SUMMARY OF THE INVENTION

The present invention addresses this issue not only through the design of the light source and the detector set, but also by introducing innovative approaches such as beam path length adjustment and multi-wavelength beam control, thereby effectively overcoming the limitations of conventional fixed-path, single-wavelength systems when detecting high-absorption samples. Therefore, the present invention explains how to effectively improve the signal-to-noise ratio when it comes to an object-to-be-measured with a strong absorption spectrum to overcome the problems in prior art by means of an innovative hardware design.

In the light of these, the objectives of the present invention are to provide a light-emitting device, a light detection device which includes the light-emitting device and a method for optical analysis by using the light detection device. There is a group of rays including a first beam and a second beam in the light-emitting device. The light-emitting device accommodates a variable dimension space to overcome the problems in prior art by means of the innovative hardware design.

The light-emitting device in the embodiments of the present invention includes a group of rays, a detector set, and a variable dimension space. The group of rays includes a first beam of a first wavelength range and of a first peak wavelength as well as a second beam of a second wavelength range and of a second peak wavelength. The first peak wavelength is different from the second peak wavelength. The detector set detects the group of rays. The variable dimension space is disposed between the group of rays and the detector set, and includes a first beam path of a first length for the first beam to pass through and a second beam path of a second length for the second beam to pass through. The first length is different from the second length.

In one embodiment, the group of rays is provided by one single light-emitting element.

In another embodiment, the first wavelength range and the second wavelength range are adjusted by adjusting an electric current of the one single light-emitting element so that the first wavelength range is different from the second wavelength range.

In another embodiment, the first peak wavelength and the second peak wavelength are adjusted by adjusting an electric current of the one single light-emitting element so that the first peak wavelength is different from the second peak wavelength.

In another embodiment, the first wavelength range and the second wavelength range are adjusted by adjusting a temperature of the one single light-emitting element so that the first wavelength range is different from the second wavelength range.

In another embodiment, the first peak wavelength and the second peak wavelength are adjusted by adjusting a temperature of the one single light-emitting element so that the first peak wavelength is different from the second peak wavelength.

In another embodiment, the group of rays further comprises a third beam of a third wavelength range and a third peak wavelength, wherein the third wavelength range is different from the first wavelength range and from the second wavelength range as well as the third peak wavelength is different from the first peak wavelength and from the second peak wavelength.

In another embodiment, the third wavelength range is adjusted by adjusting an electric current of the one single light-emitting element.

In another embodiment, the third peak wavelength is adjusted by adjusting an electric current of the one single light-emitting element.

In another embodiment, the third wavelength range is adjusted by adjusting a temperature of the one single light-emitting element.

In another embodiment, the third peak wavelength is adjusted by adjusting a temperature of the one single light-emitting element.

In another embodiment, the one single light-emitting element is a light-emitting diode, a vertical cavity surface-emitting laser, or a laser diode.

In another embodiment, the group of rays is provided by a plurality of light-emitting elements.

The light detection device in the embodiments of the present invention includes the light-emitting device and further includes a light source controller to control the group of rays and a calculator electrically connected to the detector set.

In another embodiment, the calculator correspondingly generates a first detection signal and a second detection signal according to the first beam and to the second beam. A first signal-to-noise ratio of the first detection signal is greater than a second signal-to-noise ratio of the second detection signal.

In another embodiment, the calculator correspondingly generates a third detection signal according to the third beam, wherein a third signal-to-noise ratio of the third detection signal is greater than the second signal-to-noise ratio of the second detection signal.

In the method for optical analysis according to the present invention, the light detection device is provided to receive the first beam and the second beam which respectively passed through the variable dimension space in which a fluid flows through a first beam path and through a second beam path to respectively obtain a first detection signal and a second detection signal to correspondingly generate a first analytic outcome of the fluid according to the first detection signal and to the second detection signal.

In another embodiment, the first beam path and the second beam path are adjusted by adjusting a positional parameter of the one single light-emitting element.

In another embodiment, the variable dimension of the variable dimension space is continuous.

In another embodiment, the variable dimension of the variable dimension space is discontinuous.

In another embodiment, a first signal-to-noise ratio of the first detection signal is greater than a second signal-to-noise ratio of the second detection signal.

In another embodiment, the variable dimension space further comprises a third beam path of a third length for the third beam to pass through and the fluid flows through the third beam path.

In another embodiment, the third beam path is adjusted by adjusting a positional parameter of the one single light-emitting element.

In another embodiment, the detector set receives the third beam to obtain a third detection signal for the calculator to correspondingly generate a third signal-to-noise ratio of the third detection signal according to the third detection signal, and the third signal-to-noise ratio of the third detection signal is greater than the second signal-to-noise ratio of the second detection signal.

The light-emitting device and the light detection device of the present invention emits the first beam and the second beam respectively passing through a first beam path and a second beam path which is different from the first beam path without the need to install a monochromator in the prior art to greatly reduce the volume of the optical analyzer. Moreover, the second beam path of the present invention may be well adjusted to improve the second signal-to-noise ratio based on the second detection signal to obtain a third signal-to-noise ratio which is better than the second signal-to-noise ratio to have acceptable signal-to-noise ratio when it comes to an object with a strong absorption spectrum to overcome the problems in prior art by means of the innovative hardware design proposed by the present invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a variable dimension space in a form of an adjustable mechanical structure in a light detection device according to embodiment of the present invention.

FIG. 2 illustrates another variable dimension space in a form of discontinuous room in a light detection device according to embodiment of the present invention.

FIG. 3 illustrates another variable dimension space in a form of curved continuous room in a light detection device according to embodiment of the present invention.

FIG. 4 illustrates another embodiment of a light detection device which includes the light-emitting device with the variable dimension space 120 in a form of discontinuous room to accommodate one or more different beam paths according to embodiment of the present invention.

FIG. 5 illustrates an embodiment of a method for optical analysis of optical signals of the present invention by using the light detection device.

FIG. 6 illustrates a corresponding graph of the spectral peak wavelength of a light-emitting device to the electric current of the light-emitting device and spectral FWMH to the electric density of the light-emitting device for use in the present invention.

FIG. 7 illustrates a corresponding graph of the relative spectral power distribution of a light-emitting device to the wavelength of the light-emitting device for use in the present invention.

FIG. 8 illustrates a corresponding graph of the peak wavelengths of different light-emitting devices to its junction temperature for use in the present invention.

FIG. 9 illustrates a corresponding graph of the relative spectral power distribution of a light-emitting device to the wavelength of the light-emitting device for use in the present invention.

FIG. 10 illustrates a traditional way to provide 4 beams with 4 different peak wavelengths of 4 different light-emitting diodes in prior art.

FIG. 11 illustrates a method to provide 20 beams with 20 different peak wavelengths by mere 4 different light-emitting diodes according to some embodiments of the present invention.

FIG. 12 illustrates a traditional way to provide 4 counts from 4 different light-emitting diodes in prior art.

FIG. 13 illustrates a scan method to provide 20 counts with 20 different peak wavelengths by mere 4 different light-emitting diodes according to some embodiments the present invention.

FIG. 14 illustrates a method for optical analysis of the optical signals from some fluid signal intensities via different beam paths according to some embodiments the present invention.

FIG. 15 illustrates two rays with two peak wavelengths and with two wavelength ranges out of one single light-emitting component in the light source in the light detection device according to some embodiments the present invention.

FIG. 16 illustrates the absorption spectrum of 6 signals of 1000 ppm and 2000 ppm copper sulfate aqueous solution with a standard beam path and with a shorter beam path according to some embodiments the present invention.

FIG. 17 illustrates two rays with two peak wavelengths and with two wavelength ranges from two individual light sources in the light detection device according to some embodiments the present invention.

FIG. 18 illustrates the absorption spectrum of 6 signals of 1000 ppm copper sulfate aqueous solution according to some embodiments the present invention.

FIG. 19 illustrates four rays with four peak wavelengths and with four wavelength ranges from two individual light sources in the light detection device according to some embodiments the present invention.

FIG. 20 illustrates the absorption spectrum of 8 signals of 1000 ppm copper sulfate aqueous solution according to some embodiments the present invention.

FIG. 21 illustrates a movable light source and a movable detector set in the light detection device according to some embodiments the present invention.

FIG. 22 illustrates an example of emission spectra of a laser at different driving electric currents according to some embodiments the present invention.

FIG. 23 illustrates an example of emission spectra by different hardware amplification of the laser at different driving electric currents according to some embodiments the present invention.

### DETAILED DESCRIPTION

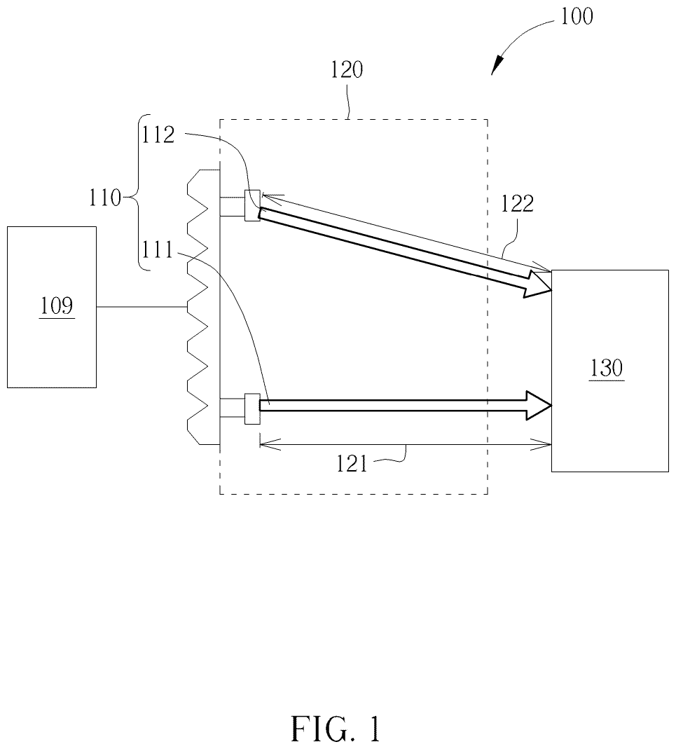

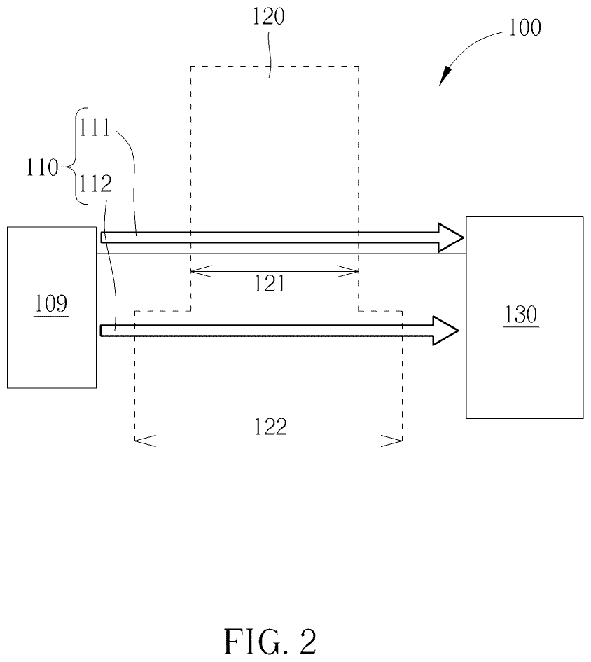

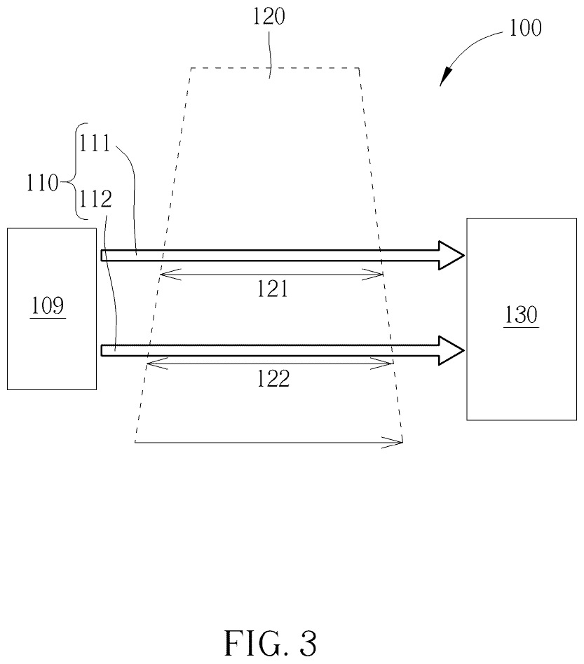

Please refer to FIG. 1, FIG. 2, and FIG. 3. They respectively illustrate various embodiments of a light-emitting device in a light detection device for use in an optical analysis of a fluid of the present invention. The light-emitting device 100 according to an embodiment of the present invention shown in FIG. 1, FIG. 2, or FIG. 3 includes a group of rays 110 from a light source 109, a variable dimension space 120, and a detector set 130.

The light source 109 may include one or more light-emitting components to emit a group of rays 110 with at least two peak wavelengths and with at least two wavelength ranges. In other words, the group of rays 110 may be provided by one single or a plurality of light-emitting elements. For example, one single light-emitting element in the light source 109 may be adjusted to provide variable wavelength ranges or peak wavelengths in the group of rays 110. There are various ways to enable the adjustment of the wavelength ranges or the peak wavelengths.

Each one of the one or more light-emitting components are selected form a group consisting of a light-emitting diode, a vertical cavity surface-emitting laser or a laser diode. Each one of the one or more light-emitting components may exhibit a continuous illumination or a discontinuous illumination of on-off frequencies. A plurality of the on-off frequencies may be the same as each other or different from each other, or a plurality of the on-off frequencies may be partially the same or partially different.

According to one example of the present invention, the group of rays 110 is provided by one single light-emitting element in the light source 109. The group of rays 110 may include at least two beams from at least one light source. The group of rays 110 for example, may include a first beam 111 and a second beam 112, or further include a third beam (not shown) or additionally a fourth beam (not shown). The quantity of beams in the group of rays 110 is not limited. For example, fewer beams in the group of rays 110 may help simplify the structure of the light-emitting device 100 or alternatively more beams in the group of rays 110 may help increase the operational range and/or at least one of the accuracy and precision of the light-emitting device 100 to perform a scan mode.

Each beam in the group of rays 110 may have a characteristic wavelength range and a characteristic peak wavelength which differs from one another. For example, the first beam 111 has a first wavelength range and a first peak wavelength, and the second beam 112 has a second wavelength range and a second peak wavelength. According to one example of the present invention, the first peak wavelength is different from the second peak wavelength. According to another example of the present invention, the first wavelength range is different from the second wavelength range, for example the first wavelength range at most partially overlap the second wavelength range, or alternatively the first wavelength range does not substantially overlap the second wavelength range. Similarly, if the third beam or the fourth beam is present, the third beam has a third wavelength range and a third peak wavelength, and the fourth beam has a fourth wavelength range and a fourth peak wavelength. According to another example of the present invention, one beam of a peak wavelength is different from another beam of another peak wavelength, and one beam of a wavelength range is different from another beam of another wavelength range. For example the third wavelength range is different from the first wavelength range and from the second wavelength range, or the third peak wavelength is different from the first peak wavelength and from the second peak wavelength.

The variable dimension space 120 is disposed between the group of rays 110 and the detector set 130. The variable dimension space 120 may include a first beam path 121 of a first length for the first beam 111 to pass through, a second beam path 122 of a second length for the second beam 112 to pass through, or a third beam path of a third length for the third beam to pass through, or additionally a fourth beam path of a fourth length for the fourth beam to pass through. Each beam path differs from one another. For example, the first length is different from the second length, from the third length and from the fourth length.

The materials of the variable dimension space 120 include glass, sapphire, quartz or acrylic or other transmissive materials, but the present invention is not limited thereto. For implementation, the variable dimension space 120 may allow a light source or a light source of a specific wavelength to pass through, so that the light source may pass through the variable dimension space 120 from one side of the variable dimension space 120 and enter the detector set 130.

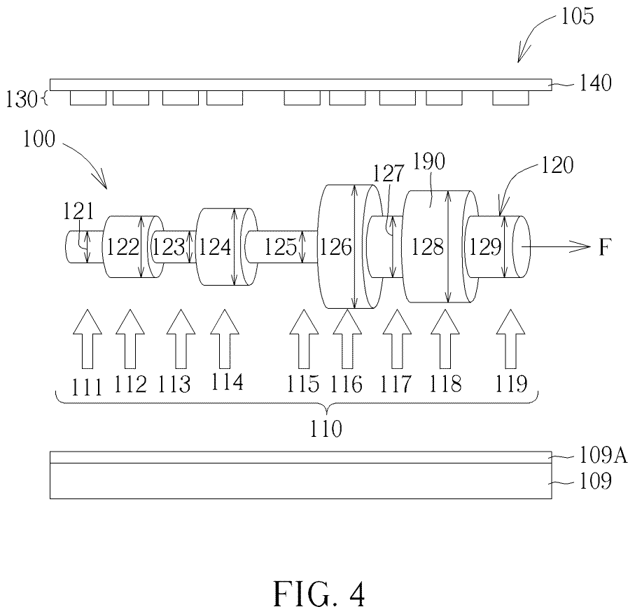

The variable dimension space 120 enables the above mentioned different beam paths to show various embodiments. For example, FIG. 1 illustrates the variable dimension space 120 in a form of an adjustable mechanical structure to accommodate one or more different beam paths. Examples of an adjustable mechanical structure may be transparent or translucent. By adjusting the distance between two light-transmitting planes, different optical path lengths can be provided. FIG. 2 illustrates the variable dimension space 120 is in a form of discontinuous room to accommodate one or more different beam paths. Examples of discontinuous room may be a set of various connected containers such as cubes, cuboids to form a transparent or translucent communicating vessel to accommodate a flowing fluid (shown in FIG. 4), but the present invention is not limited thereto. FIG. 3 illustrates the variable dimension space 120 is in a form of curved continuous room to accommodate one or more different beam paths. Examples of curved continuous room may be a transparent or translucent communicating vessel with variable cross section dimensions to accommodate the flowing fluid, but the present invention is not limited thereto.

The detector set 130 receives one or more beams emitted from the light source 109, and one or more beams may pass through the variable dimension space 120. The travel path between the light source 109 and the detector set 130 forms a beam path to detect the flowing fluid and generate a spectrum chart of a corresponding absorption spectrum, transmission spectrum or reflection spectrum, and through the analysis of the spectral chart when the related information of the flowing fluid is known. The detector set 130 may include, for example, a photodetector, a photo diode, an organic photo diode, a photomultiplier, a photoconducting detector, a Si bolometer, an one-dimensional or multi-dimensional photo diode array, an one-dimensional or multi-dimensional CCD (Charge Coupled Device) array, an one-dimensional or multi-dimensional CMOS (Complementary Metal-Oxide-Semiconductor) array, an image sensor (19), a camera, a spectrometer or a hyperspectral camera. A flowing fluid is placed in the beam path which penetrates the flowing fluid.

FIG. 4 illustrates another embodiment of a light detection device 105 which include the light-emitting device 100 with the variable dimension space 120 in a form of discontinuous room to accommodate one or more different beam paths. The light detection device 105 according to the illustration shown in FIG. 4 in addition to the light-emitting device 100, further includes a light source controller 109A to control the light source 109, and a calculator 140. Please refer to the above descriptions for the details of the light-emitting device 100.

The light source controller 109A controls the light source 109 to emit a plurality of light rays in sequence if different beams are provided by one single light-emitting component, or alternatively simultaneously if there are multiple light-emitting components to emit different beams to different detectors in the detector set 130. The light source 109 is able to emit the group of rays 110. In FIG. 4, for example, the group of rays 110 includes the first beam 111, the second beam 112, a third beam 113, a fourth beam 114, a fifth beam 115, a sixth beam 116, a seventh beam 117, an eighth beam 118, and a ninth beam 119, but the present invention is not limited thereto. According to one example of the present invention, one beam may be the same or different from another beam in the group of rays 110.

The light source 109 is electrically connected to the light source controller 109A so that the light source controller 109A is able to control the group of rays 110 shown in FIG. 4 by adjusting the light source 109, for example, by adjusting an electric current or a temperature of the light source 109. When one characteristic parameter, such as an electric current or a temperature, of the light source 109 is adjusted, one or more optical parameters, such as the wavelength range or the peak wavelength are correspondingly adjusted to create multiple different beams.

According to one embodiment of the present invention, the first wavelength range and the second wavelength range are adjusted, such as adjusted by the light source controller 109A to adjust an electric current of the one single light-emitting element in the light source 109 so that the first wavelength range is different from the second wavelength range. According to another embodiment of the present invention, the first peak wavelength and the second peak wavelength are adjusted, such as adjusted by the light source controller 109A to adjust an electric current of the one single light-emitting element in the light source 109 so that the first peak wavelength is different from the second peak wavelength. According to another embodiment of the present invention, the first wavelength range and the second wavelength range are adjusted, such as adjusted by the light source controller 109A to adjust a temperature of the one single light-emitting element in the light source 109 so that the first wavelength range is different from the second wavelength range. According to another embodiment of the present invention, the first peak wavelength and the second peak wavelength are adjusted, such as adjusted by the light source controller 109A to adjust a temperature of the one single light-emitting element in the light source 109 so that the first peak wavelength is different from the second peak wavelength. Optionally, the third wavelength range and/or the third peak wavelength is adjusted, such as adjusted by the light source controller 109A to adjust an electric current of the one single light-emitting element in the light source 109. Alternatively, the third wavelength range and/or the third peak wavelength is adjusted, such as adjusted by the light source controller 109A to adjust a temperature of the one single light-emitting element in the light source 109.

The variable dimension space 120 shown in FIG. 4 may have various beam paths corresponding to the beams in the group of rays 110 or corresponding to different positions of the beams. For example, there are a first beam path 121 corresponding to the first beam 111, a second beam path 122 corresponding to the second beam 112, a third beam path 123 corresponding to the third beam 113, a fourth beam path 124 corresponding to the fourth beam 114, a fifth beam path 125 corresponding to the fifth beam 115, a sixth beam path 126 corresponding to the sixth beam 116, a seventh beam path 127 corresponding to the seventh beam 117, an eighth beam path 128 corresponding to the eighth beam 118, and a ninth beam path 129 corresponding to the ninth beam 119. According to one example of the present invention, a length of one beam path may be the same or different from a length of another beam path in the variable dimension space 120, for example a first length of a first beampath is different from a second length of a second beam path. The actual length of one beam path is neither important nor critical. What matters is the difference between two beam paths for use in the present invention. For example, one is longer or shorter than another one.

A fluid 190 flows through the variable dimension space 120 along a flowing direction F, for example from the first beam path 121 toward the ninth beam path 129 sequentially flows through the first beam path 121, the second beam path 122, the third beam path 123, the fourth beam path 124, the fifth beam path 125, the sixth beam path 126, the seventh beam path 12, the eighth beam path 128 and the ninth beam path 129 so that the first beam 111 the second beam 112 and the third beam 113 respectively pass through the fluid 190. The fluid 190 may be a liquid, a gas or a mixture thereof. Optionally, there may be a solid dispersed in the fluid 190. For example, the fluid 190 may be a production solution for use in a printed circuit board (PCB), a semiconductor, a petrochemical industry or the food processing industry, and the standard transmittance can be converted into the composition ratio and concentration of the fluid-to-be-measured 0, which are required for normal operation.

The detector set 130 converts the aforementioned beam into an image signal, into a spectral signal of the flowing fluid, into a voltage signal and/or a current signal, and transmits the image signal, the spectral signal of the flowing fluid, the voltage signal and/or the current signal to the calculator 140. An image drawing and/or a fluid spectral drawing is formed after the calculator 140 converts the image signal and/or the spectral signal of the fluid. In other words, the detector set 130 includes an image extractor and/or a light detector which are electrically connected. For example, the image extractor may be a camera, a CCD or a CMOS to convert the beam into the image signal. The detector set 130 may be a spectrometer to convert the beam into the spectral signal of the fluid. For another example, the aforementioned photo diode can convert the beam into the voltage signal or into the current signal.

The calculator 140 is electrically connected to the detector set 130 to calculate or further analyze the signals obtained by the detector set 130. The calculator 140 correspondingly generates a first detection signal and a second detection signal according to the first beam 111 and to the second beam 112, and may further correspondingly generate a first analytic outcome of the fluid 190 according to the first detection signal and to the second detection signal. If the third beam 113 is present, the calculator 140 correspondingly generates a third detection signal according to the third beam 113.

A detection signal may include a fluid signal intensity and a noise signal intensity. The fluid signal intensity is the transmissive intensity of a certain beam after passing through the fluid. The noise signal intensity is signal intensity from the background and may be substantially constant relative to the variable fluid signal intensity. It is defined that: signal-to-noise ratio =(fluid signal intensity)/(corresponding noise signal intensity)

By way of example, the calculator 140 may individually compute a first signal-to-noise ratio and a second signal-to-noise ratio. The signal-to-noise ratio may serve as an indicator of the analytical performance of the device. The calculator 140 may be a processor if the calculator 140 serves as an analyzer.

The fluid signal intensity is weaker than the original signal intensity of the given beam. When it comes to a fluid with a strong absorption band in the absorption spectrum, the fluid signal intensity may be too weak to significantly outperform the corresponding noise signal intensity. The prior art fails to solve a problem when the fluid signal intensity is too weak to significantly outperform the corresponding noise signal intensity, in other words, the signal-to-noise ratio is not great enough, for example not greater than a threshold value to result in a good signal resolution.

For example, please refer to FIG. 4, the detector set 130 receives the first beam 111 emitted from the light source 109 and along the first beam path 121 to obtain a first fluid signal intensity 111I. Along with the first fluid signal intensity 111I, a first noise signal intensity 111W is also received by the detector set 130. Moreover, the detector set 130 receives the second beam 112 emitted from the light source 109 and along second beam path 122 to obtain a second fluid signal intensity 112I. Along with the second fluid signal intensity 112I, a second noise signal intensity 112W is also received by the detector set 130. After calculated by the calculator 140, it is determined that the second fluid signal intensity 112I is weaker than the first fluid signal intensity 111I, that is 112I<111I, and weaker than the threshold value, too. Accordingly, the second fluid signal intensity 112I is determined to be unacceptable and needs optimizing.

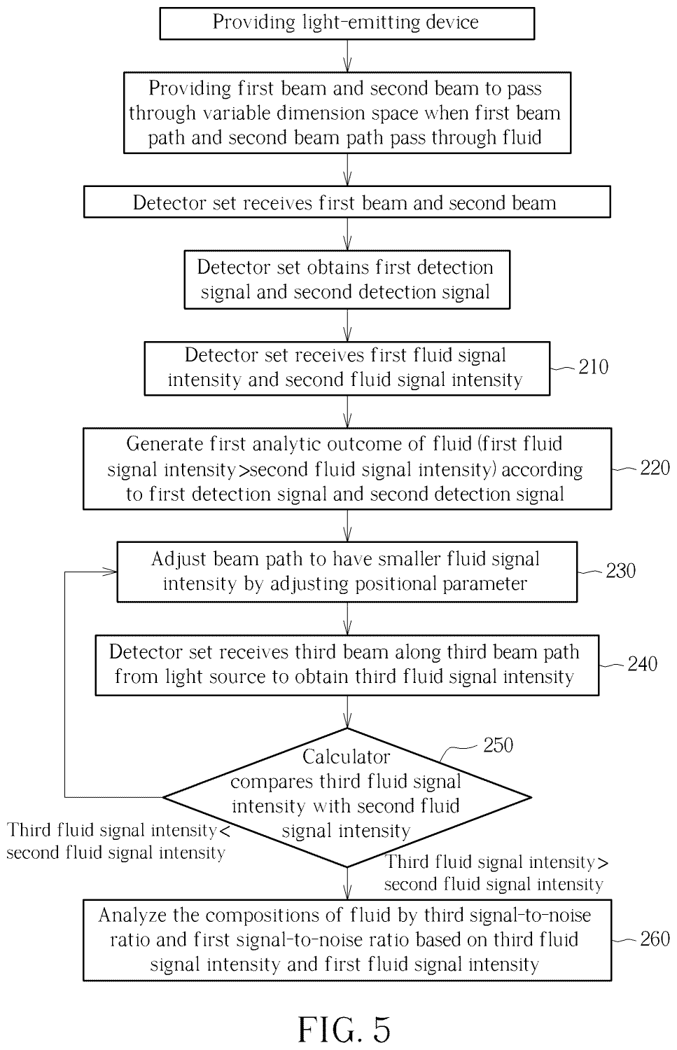

FIG. 5 illustrates an embodiment of a method for optical analysis of optical signals of the present invention by using the light detection device 105 which include the light-emitting device 100 with the variable dimension space 120. The present invention provides a better signal-to-noise ratio than a threshold value to result in a better signal resolution by adjusting the second beam path 122 relative to the first beam path 121. The method for optical analysis of the present invention may include at least the following steps.

### Step 210

In STEP 210, as discussed above, the first fluid signal intensity 111I and the second fluid signal intensity 1211 are respectively received.

### Step 220

In STEP 220, as discussed above, it is determined that 112I<111I, in other words a first signal-to-noise ratio of the first detection signal is greater than a second signal-to-noise ratio of the second detection signal.

### Step 230

In STEP 230, a beam path with a smaller fluid signal intensity in STEP 220 is adjusted by adjusting a positional parameter. According to one example of the present invention, at least one of the first beam path 121, the second beam path 122 and the third beam path 123 is adjusted by adjusting a positional parameter of the one single light-emitting element. For example, the beam path before the adjustment is called the second beam path 122 and the beam path after the adjustment is called the third beam path 123, optionally with the identical beam so that a length of the third beam path 123 is shorter than the second beam path 122. For example, the location of the second beam 112 is moved from the second location 12C to the third location 13C so that the length of the third beam path 123 is shorter than the length of the second beam path 122 as shown in FIG. 4.

### Step 240

In STEP 240, the detector set 130 receives the third beam 113 emitted from the light source 109 and along the third beam path 123 to obtain a third fluid signal intensity 1131. Along with the third fluid signal intensity 1131, a third noise signal intensity 113W is also received by the detector set 130.

### Step 250

In STEP 250, the newly obtained third fluid signal intensity 1131 is compared with the second fluid signal intensity 112I by the calculator 140. According to one example of the present invention, a third signal-to-noise ratio based on the third fluid signal intensity 1131 and the third noise signal intensity 113W is compared with the second signal-to-noise ratio. According to one example of the present invention, the third signal-to-noise ratio of the third detection signal is greater than the second signal-to-noise ratio of the second detection signal.

If the third signal-to-noise ratio is better than the second signal-to-noise ratio, the objective of the present invention to enhance the signal-to-noise ratio is achieved to go to STEP 250. According to another example of the present invention, the third signal-to-noise ratio is better than the first signal-to-noise ratio.

If the objective of the present invention is not achieved, go back to STEP 230 to determine another shorter beam path.

### Step 260

In STEP 260, the third signal-to-noise ratio and the first signal-to-noise ratio are used to analyze the compositions of the fluid 190. After the above steps, another objective of the present invention which optimizes the second signal-to-noise ratio so that the third signal-to-noise ratio may be even better than the first signal-to-noise ratio is achieved.

As described above, one characteristic parameter, such as an electric current or a temperature, of the light source 109 is adjusted, so one or more optical parameters, such as the wavelength range or the peak wavelength are correspondingly adjusted to create multiple different beams. The wavelength of an LED/Laser itself, generally defined as the peak wavelength, is susceptible to the current density or a junction temperature Tj of the light-emitting device.

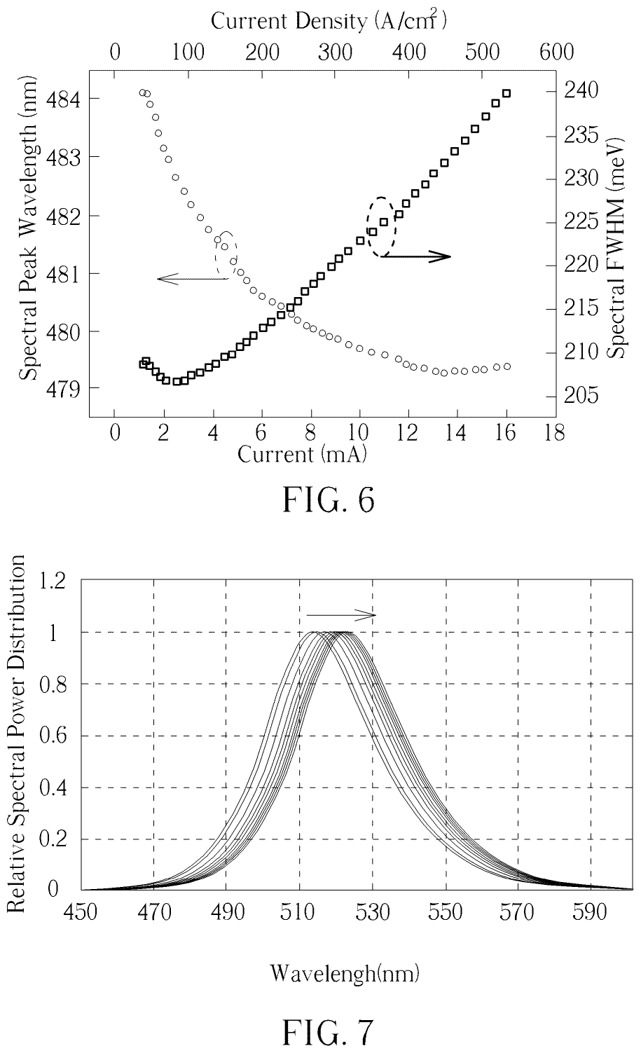

FIG. 6 illustrates a corresponding graph of the spectral peak wavelength of a light-emitting device to the electric current of the light-emitting device and spectral FWMH to the electric density of the light-emitting device for use in the present invention. FIG. 7 illustrates a corresponding graph of the relative spectral power distribution of a light-emitting device to the wavelength of the light-emitting device for use in the present invention.

As shown in FIG. 6 or in FIG. 7, the light source of the quantum well structure is affected by the band filling effect and shows a blue shift when the current density increases. The thermal effect takes over as the current increases to turn into a red shift. Therefore, the emission wavelength of an LED/laser light are adjusted by adjusting the driving electric current from a low electric current to a high electric current to obtain different emission wavelength peaks, and to achieve the purpose of multi-band measurement.

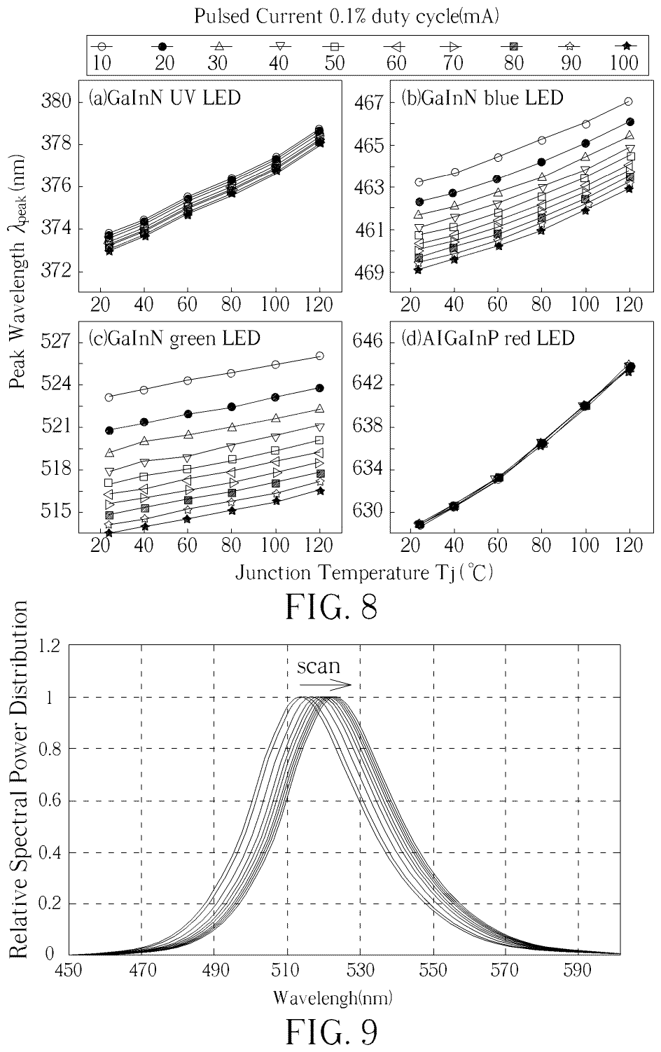

FIG. 8 illustrates a corresponding graph of the peak wavelengths of different light-emitting devices to its junction temperature for use in the present invention. FIG. 9 illustrates a corresponding graph of the relative spectral power distribution of a light-emitting device to the wavelength of the light-emitting device for use in the present invention. When the temperature increases, the bandgap energy of a semiconductor material decreases as the temperature rises. Because the lattice vibration (phonon activity) becomes more intense, the electron energy state distribution and the structure of the conduction band/valence band change. This causes the energy required for electrons to jump from the valence band to the conduction band to decrease, resulting in lower energy and longer wavelength (red shift) of the photons produced.

Therefore, the ambient temperature of the LED/Laser may be adjusted to increase the emission peak wavelength. If the temperature is changed step by step, multiple groups of emission peak wavelength can be obtained.

The following embodiments are given to elaborate some modes of the present invention but the scope of the present invention is not limited by the embodiments.

### Embodiment 1

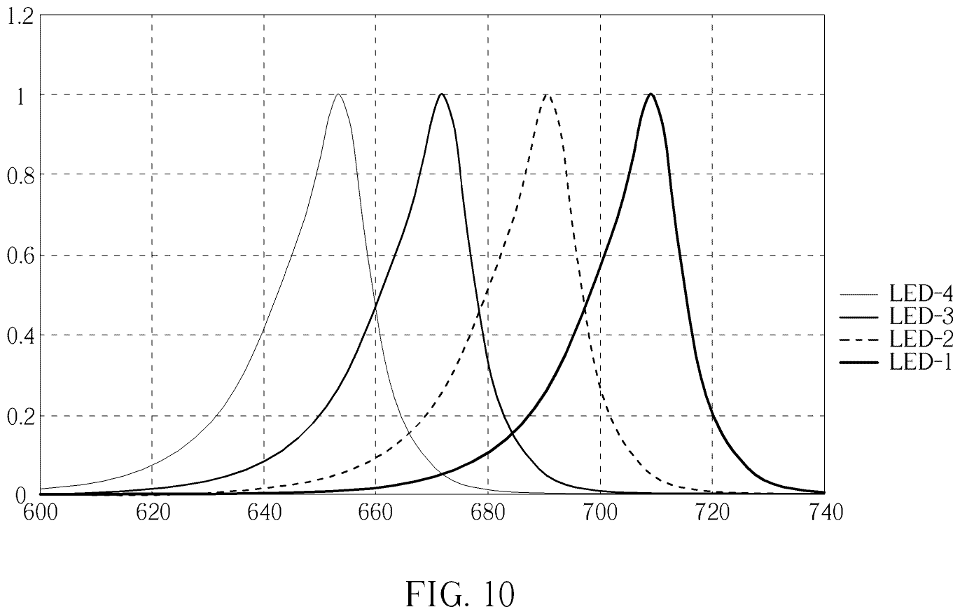

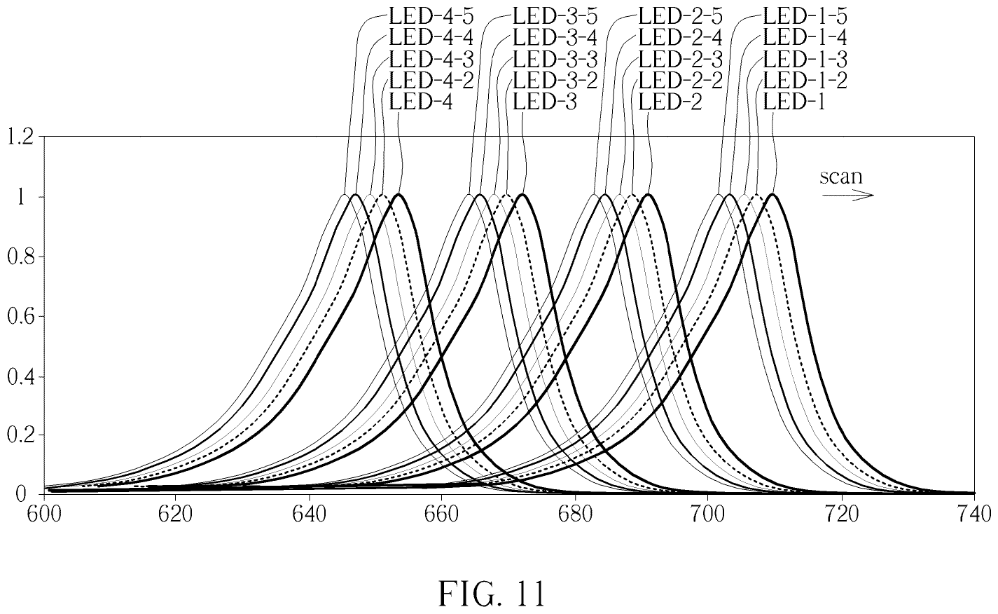

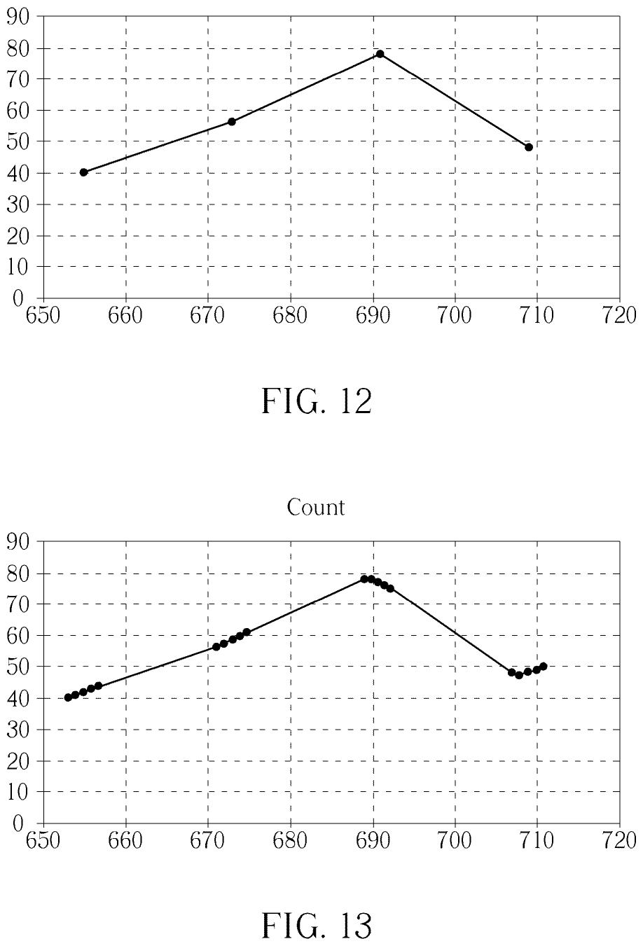

FIG. 10 illustrates a traditional way to provide 4 beams with 4 different peak wavelengths of 4 different light-emitting diodes in prior art while FIG. 11 illustrates a method to provide 20 beams with 20 different peak wavelengths by mere 4 different light-emitting diodes for use in the present invention. FIG. 12 illustrates a traditional way to provide 4 counts from 4 different light-emitting diodes in prior art while FIG. 13 illustrates a method to provide 20 counts with 20 different peak wavelengths by mere 4 different light-emitting diodes for use in the present invention.

Traditionally, there are only four peak wavelengths available for a system with only four LED light sources with mutually different emission peak wavelengths, as shown in FIG. 10. In other words, the resultant spectrum can only have four points, in other words four counts.

The present invention proposes a novel method to adjust a characteristic parameter, such as an electric current or a temperature, of one light-emitting element in the light source 109 to correspondingly adjust the emission optical parameters, such as the wavelength range and/or the peak wavelength to create multiple different beams of different wavelength ranges or of different peak wavelengths out of one single light-emitting element to result in more counts.

First Method: The driving electric current of an LED is adjusted while turned on and off sequentially. The current density of the LED changes to result in a shift in wavelength by referring to the data shown in FIG. 6.

Second Method: The junction temperature of an LED is adjusted while turned on and off sequentially. The junction temperature of the LED changes to result in a shift in wavelength by referring to the data shown in FIG. 8.

FIG. 11 illustrates how to provide 20 beams with 20 different peak wavelengths by mere 4 different light-emitting diodes.

### Scan Concept

EMBODIMENT 1 further provides another novel mode, namely scan concept. Please refer to FIG. 13. If the modulation interval of the current density is changed, multiple groups of emission peak wavelengths are resultantly formed so it is also possible to adjust the current density of a given light-emitting element to a very small interval level and scan the interval successively to form a large number group of emission peak wavelengths to achieve the purpose of frequency scanning. Therefore, if the spectrum is measured in the above way with a large number of different beams, the spectral resolution of the fluid 190 can be greatly improved by the presence of a large number group of beams with mutually different emission peak wavelengths.

A scan mode may be enabled by adjusting the emission wavelength by changing the driving conditions or the environments of the solid-state light source (laser, LED . . . etc.). For example, the efficacy of gradually changing the emission wavelength may be achieved by a smaller change of driving conditions or the environment. With a gradual change of the emission wavelength, the corresponding transmittance or reflectance is measured at each wavelength to achieve the efficacy of frequency scanning.
4. During the operation of frequency scanning, the luminous intensity of a given light source may be adjusted by changing a driving condition or the environment. The following three methods may be used to adjust the luminous intensity:
1. to change the beam paths;
2. to adjust the hardware amplification; or
c. adjusted by software.

### Embodiment 2

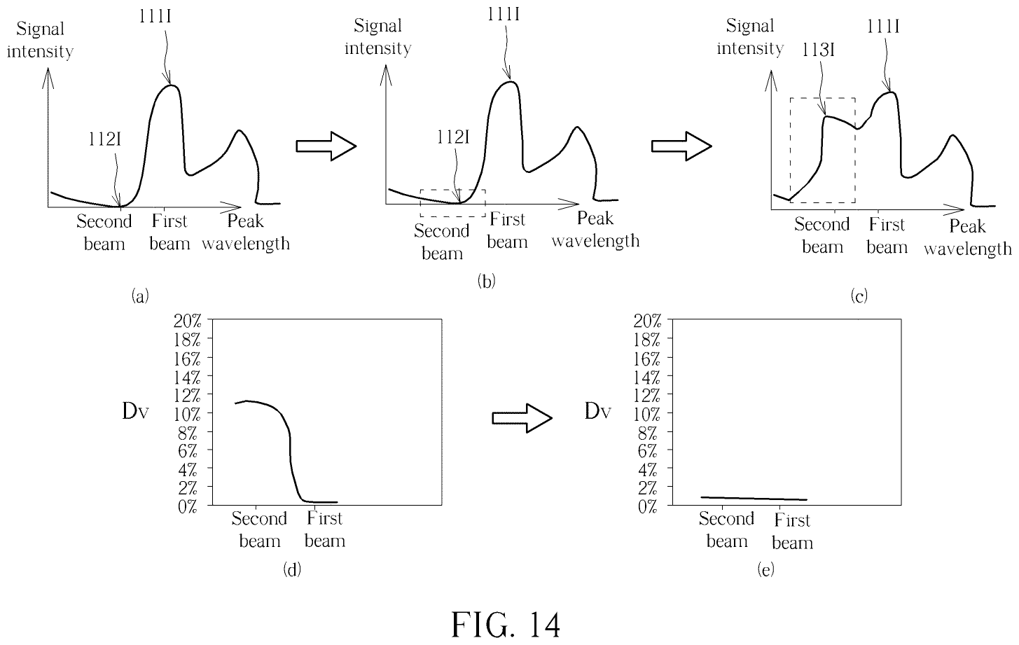

The optical data obtained by the method for optical analysis of optical signals of the present invention by using the light detection device 105 which include the light-emitting device 100 with the variable dimension space 120 are provided. FIG. 14 illustrates some fluid signal intensities regarding different beam paths of the present invention.

The results of the method of the present invention provide a better signal-to-noise ratio than a threshold value to have a better deviation value. Please refer to FIGS. 4 and 5 for the details of the method.

### Step 210

In STEP 210, as shown in (a) of FIG. 14, a fluid 190 passes through the variable dimension space 120 in the light detection device 105 when the first beam 111 penetrates the fluid 190 via the first beam path 121 and the second beam 112 penetrates the fluid 190 via the second beam path 122 so that the detector set 130 respectively receives the first beam 111 and the second beam 112 after they respectively pass through the fluid 190 to generate the first fluid signal intensity 111I and the second fluid signal intensity 1211 by the calculator 140.

### Step 220

In STEP 220, as shown in (b) of FIG. 14, it is determined by the calculator 140 that the first fluid signal intensity 111I is greater than the second fluid signal intensity 1211, that is 111I>112I. Furthermore, the second fluid signal intensity 1211 is too weak to significantly outperform the corresponding noise signal intensity, in other words, the second signal-to-noise ratio is not greater than a threshold value.

### Step 230

In STEP 230, as shown in (c) of FIG. 14, the second beam 112 is moved from the second location 12C to a third location 13C to obtain the third fluid signal intensity 1131. The same second beam 112 penetrates the fluid 190 via a new third beam path 123. A length of the third beam path 123 is shorter than a length of the second beam path 122. The fluid signal intensity of each beam path may be measured more than once to be statistically significant.

As shown in (d) of FIG. 14, an original deviation value is calculated by the calculator 140 based on the first fluid signal intensity 111I or the second fluid signal intensity 112I in accordance with the following formula:

Deviation Value(Dv)=(Max−Min)/Avg

In which: Max refers to the maximal value among the multiple fluid signal intensities; Min refers to the minimal value among the multiple fluid signal intensities; Avg refers to the average value of all the multiple fluid signal intensities.

The second fluid signal intensities, the wavelength used to obtain the second fluid signal intensities and the corresponding Deviation Value are given in Table 1.

TABLE 1

| Wavelength (nm) | 481.818182 |
|---|---|
| Measurement 1 - Trial 1 | 29.214% |
| Measurement 1 - Trial 2 | 29.220% |
| Measurement 1 - Trial 3 | 29.302% |
| Measurement 1 - Trial 4 | 32.595% |
| Measurement 1 - Trial 5 | 32.070% |
| Avg | 30.480% |
| Deviation Value (Dv) | 11.092% |

As shown in (e) of FIG. 14, an adjusted deviation value is calculated by the calculator 140 based on the third fluid signal intensity 1131 in accordance with the Dv formula. The third fluid signal intensities, the wavelength used to obtain the third fluid signal intensities and the corresponding Deviation Value are given in Table 2.

TABLE 2

| Wavelength (nm) | 481.818182 |
|---|---|
| Measurement 2 - Trial 1 | 79.977% |
| Measurement 2 - Trial 2 | 80.183% |
| Measurement 2 - Trial 3 | 79.789% |
| Measurement 2 - Trial 4 | 80.839% |
| Measurement 2 - Trial 5 | 80.589% |
| Avg | 80.275% |
| Deviation Value (Dv) | 1.308% |

The Dv formula is proposed by the present invention to evaluate the quality of the fluid signal intensities of a given beam path after multiple measurements.

It is suggested that the smaller the Dv is, the better the reproducibility is. A smaller Dv also represents a higher signal-to-noise ratio, namely less susceptible to the background noise signal. It is observed that the method for the optical analysis of the optical signals of the present invention is able to greatly improve the second Deviation Value from 17.60% to the third Deviation Value 3.39% to support the efficacy of the present invention.

### Embodiment 3

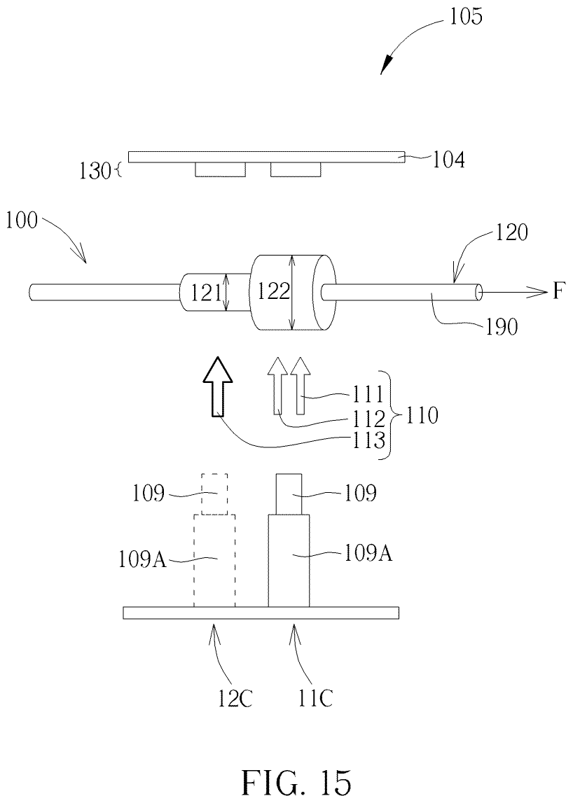

Please refer to FIG. 15 for the light detection device 105 for use in this embodiment. The light detection device 105 shown in FIG. 15 includes a group of rays 110 from a light source 109, a light source controller 109A to control the light source 109, a variable dimension space 120, a fluid 190 in the variable dimension space 120, a detector set 130 and a calculator 140. One single light-emitting component in the light source 109 to emit two rays 110 with two peak wavelengths and with two wavelength ranges is given in this embodiment.

A GaN laser with a peak emission wavelength of 390 nm is used to measure the absorption spectrum of a copper sulfate aqueous solution of 1000 ppm and 2000 ppm. First, the chambers 1 and 2 in the variable dimension space 120 are empty to make sure there is no liquid in the variable dimension space 120. Second, the light source 109 is placed at the first location 11C and emits a first beam 111 with an electric current of 100 mA. The first beam 111 is received by the detector set 130 to measure a signal B91-empty via a first beam path 121. Third, the light source 109 is placed at the first location 11C and emits a second beam 112 with an electric current of 200 mA. The second beam 112 is received by the detector set 130 to measure a signal B92-empty via the first beam path 121.

Fourth, a copper sulfate aqueous solution of 1000 ppm is injected into the chambers 1 and 2 in the variable dimension space 120 to serve as the fluid 190. Fifth, the light source 109 is placed at the first location 11C and emits the first beam 111 with an electric current of 100 mA. The first beam 111 is received by the detector set 130 to measure a signal B91-1000 via the first beam path 121. Sixth, the light source 109 is placed at the first location 11C and emits the second beam 112 with an electric current of 200 mA. The second beam 112 is received by the detector set 130 to measure a signal B92-1000 via the first beam path 121.

The above measurements are respectively repeated 5 times to calculate the Dvs of the two wavelengths with respect to the two copper sulfate aqueous solutions. The optical data and the resultant Dv for a peak wavelength of 390 nm with an electric current of 100 mA via the standard first beam path 121 after 5 measurements are shown in Table 3.

TABLE 3
390 nm at 100 mA current with standard
beam path (CuSO₄, 1000 ppm)

| | |
|---|---|
| Measurement 1 - 100 mA -1 | 78.30% |
| Measurement 1 - 100 mA -2 | 79.60% |
| Measurement 1 - 100 mA -3 | 79.53% |
| Measurement 1 - 100 mA -4 | 80.40% |
| Measurement 1 - 100 mA -5 | 82.16% |
| Avg | 80.00% |
| Deviation Value (Dv) | 4.83% |

The optical data and the resultant Dv for a peak wavelength of 390.5 nm with an electric current of 200 mnA via the standard first beam path 121 after 5 measurements are shown in Table 4.

TABLE 4
390.5 nm at 200 mA current with standard
beam path (CuSO₄, 1000 ppm)

| | |
|---|---|
| Measurement 2 - 200 mA -1 | 78.71% |
| Measurement 2 - 200 mA -2 | 79.30% |
| Measurement 2 - 200 mA -3 | 79.59% |
| Measurement 2 - 200 mA -4 | 79.88% |
| Measurement 2 - 200 mA -5 | 80.47% |
| Avg | 79.59% |
| Deviation Value (Dv) | 2.21% |

It is observed that the Dv at the 390 nm band is poor due to its low intensity. Therefore, a method for the improvement of the Dv is proposed as follows:

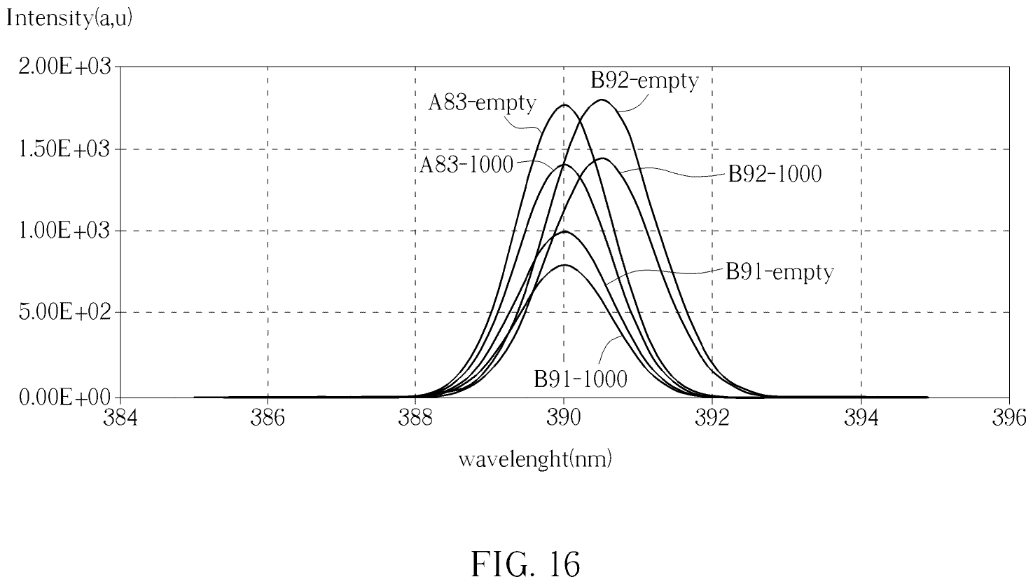

First, the chambers 1 and 2 in the variable dimension space 120 are drained to make sure there is no liquid in the variable dimension space 120. Second, the same light source 109 originally placed at the first location 11C is move to a second location 12C to emit third beam 113 with an electric current of 100 mnA. The third beam 113 is received by the detector set 130 to measure a signal A83-empty via a second beam path 122 which is shorter than the first beam path 121. Third, the copper sulfate aqueous solution of 1000 ppm is injected into the chambers 1 and 2 in the variable dimension space 120 to serve as the fluid 190. Fourth, the light source 109 is placed at the second location 12C and emits the third beam 113 with an electric current of 100 mA. The third beam 113 is received by the detector set 130 to measure a signal A83-1000 via the second beam path 122. The absorption spectrum of the above 6 signals of the copper sulfate aqueous solution of 1000 ppm and the 2000 ppm with a standard beam path and with a shorter beam path is shown in FIG. 16.

The above measurements are respectively repeated 5 times to calculate the Dvs of the two wavelengths with respect to the two copper sulfate aqueous solutions. The optical data and the resultant Dv for a peak wavelength of 390 nm with an electric current of 100 mA with a shorter second beam path 122 after 5 measurements by using the method for the improvement of the Dv are shown in Table 5.

TABLE 5
390 nm at 100 mA current with shorter
beam path (CuSO₄, 1000 ppm)

| | |
|---|---|
| Measurement 3 - 100 mA -1 | 78.97% |
| Measurement 3 - 100 mA -2 | 79.55% |
| Measurement 3 - 100 mA -3 | 79.90% |
| Measurement 3 - 100 mA -4 | 80.25% |
| Measurement 3 - 100 mA -5 | 80.82% |
| Avg | 79.90% |
| Deviation Value (Dv) | 2.32% |

It is observed that the second beam path 122 is shorter than the first beam path 121 so the overall Dv (2.32%<4.83%) and the corresponding signal-to-noise ratio of 390 nm are improved.

It is observed in EMBODIMENT 3 that the emission peak wavelength become longer from 390 nm to 390.5 nm when the driving electric current is increased from 100 mA to 200 mA. Similarly, it is derived from EMBODIMENT 3 that the emission peak wavelength becomes longer from 390 nm to 390.5 nm and 394 nm when the driving electric current is increased from 100 mA to 200 mA and 300 mA. The transmittance of copper sulfate aqueous solution increases as the wavelength increases from about 390 nm toward the visible light region. By increasing the measurement points by using different wavelengths, the quantitative analysis capability of the spectrum can be further enhanced.

Furthermore, by reducing the differences among the different driving current modulation, the measurement resolution can be increased. For example, if an electric current measurement is set to be every 10 mA, a total of a group of rays including beams with 10 different peak wavelengths is obtained. However, if an electric current measurement is set to be every 1 mA, a total of a group of rays including beams with 100 different peak wavelengths may be obtained to enable the above mentioned scan concept so ten sets or hundred sets of measurement points or counts may be additionally added with different peak wavelengths to increase the measurement resolution.

### Embodiment 4

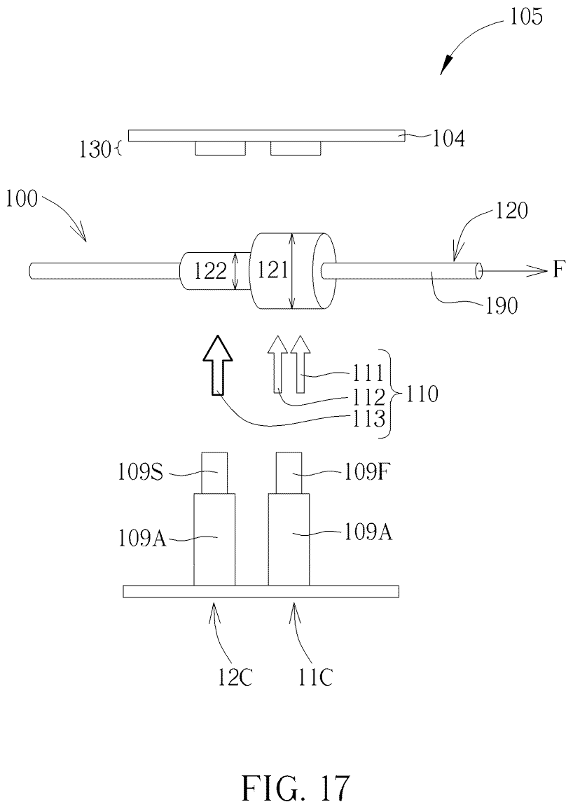

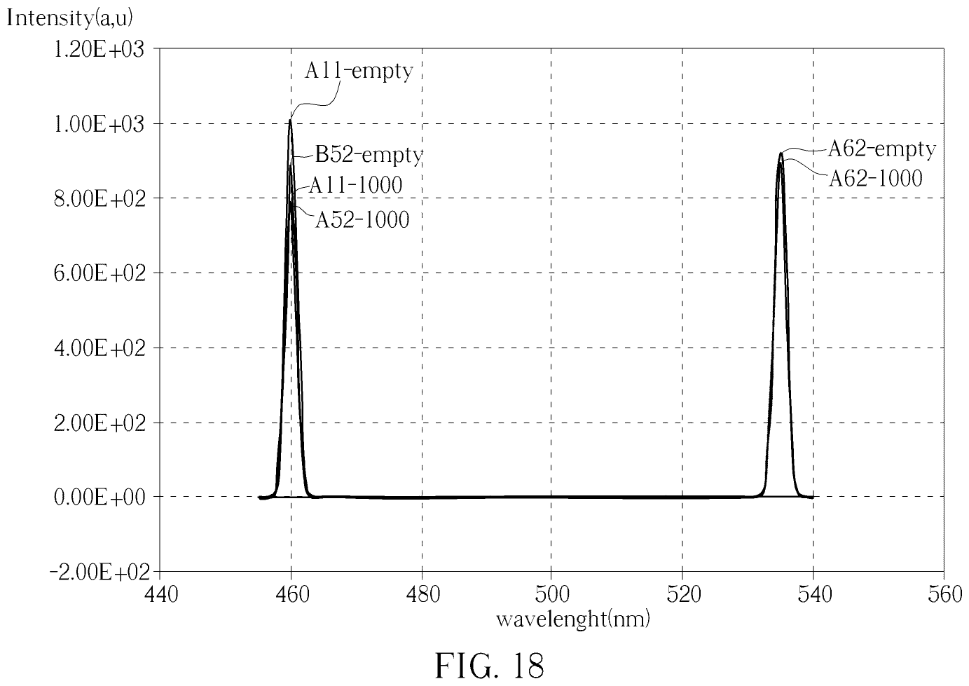

Please refer to FIG. 18 for the light detection device 105 for use in this embodiment. The light detection device 105 shown in FIG. 17 is similar to what is illustrated in FIG. 15. The major difference between the two is that EMBODIMENT 4 includes a group of rays 110 from two individual light sources, namely a light source 109F and a light source 109S to emit two rays 110 with two peak wavelengths and with two wavelength ranges in this embodiment. Please refer to EMBODIMENT 3 for the details of other elements.

A GaN laser with a peak emission wavelength of 460 nm and a GaN laser with a peak emission wavelength of 535 nm are respectively used to measure the absorption spectrum of a copper sulfate aqueous solution of 1000 ppm. First, the chambers 1 and 2 in the variable dimension space 120 are empty to make sure there is no liquid in the variable dimension space 120. Second, the light source 109F is placed at the first location 11C and emits a second beam 112 with an electric current of 100 mA. The second beam 112 is received by the detector set 130 to measure a signal B62-empty via a first beam path 121. Third, the light source 109S is placed at the first location 11C and emits a first beam 111 with an electric current of 100 mA. The first beam 111 is received by the detector set 130 to measure a signal B52-empty via the first beam path 121.

Fourth, a copper sulfate aqueous solution of 1000 ppm is injected into the chambers 1 and 2 in the variable dimension space 120 to serve as the fluid 190. Fifth, the light source 109F is placed at the first location 11C and emits the second beam 112 with an electric current of 100 mA. The second beam 112 is received by the detector set 130 to measure a signal B62-1000 via the first beam path 121. Sixth, the light source 109S is placed at the first location 11C and emits the first beam 111 with an electric current of 100 mA. The first beam 111 is received by the detector set 130 to measure a signal B52-1000 via the first beam path 121.

It is observed that the signal B52-1000 is weaker than the signal B62-1000 due to its lower intensity. Therefore, a method for the improvement of the signal intensity is proposed to adjust the beam path as follows:

Seventh, the chambers 1 and 2 in the variable dimension space 120 are drained to make sure there is no liquid in the variable dimension space 120. Eighth, the light source 109S is placed at the second location 12C and emits a third beam 113 with an electric current of 100 mA. The third beam 113 is received by the detector set 130 to measure a signal A111-empty via a second beam path 122 which is shorter than the first beam path 121. Ninth, the copper sulfate aqueous solution of 1000 ppm is injected into the chambers 1 and 2 in the variable dimension space 120 to serve as the fluid 190. Tenth, the light source 109S is placed at the second location 12C and emits third beam 113 with an electric current of 100 mA. The third beam 113 is received by the detector set 130 to measure a signal A111-1000 via the second beam path 122. The absorption spectrum of the above 6 signals of the copper sulfate aqueous solution of 1000 ppm is shown in FIG. 18.

The above measurements are respectively repeated 5 times to calculate the Dvs of the transmittance of the two wavelengths. The optical data and the resultant Dv for the peak wavelengths of 460 nm and of 535 nm with an electric current of 100 mA via a standard beam path and via a shorter beam path after 3 measurements by using the method for the improvement of the Dv are respectively shown in Table 6 and in Table 7.

TABLE 6

| | 535.1171 nm with |
|---|---|
| peak wavelength and beam path | standard path |
| 535-1000 ppm transmittance-1 | 96.793% |
| 535-1000 ppm transmittance-2 | 97.127% |
| 535-1000 ppm transmittance-3 | 97.356% |
| Avg | 97.092% |
| Deviation Value (Dv) | 0.58% |

TABLE 7

| | 460 nm with | 460 nm with |
|---|---|---|
| peak wavelength and beam paths | shorter path | standard path |
| 460-1000 ppm-transmittance-1 | 88.62% | 77.481% |
| 460-1000 ppm-transmittance-2 | 89.045% | 78.090% |
| 460-1000 ppm-transmittance-3 | 88.891% | 78.229% |
| Deviation Value (Dv) | 0.48% | 0.96% |

### Embodiment 5

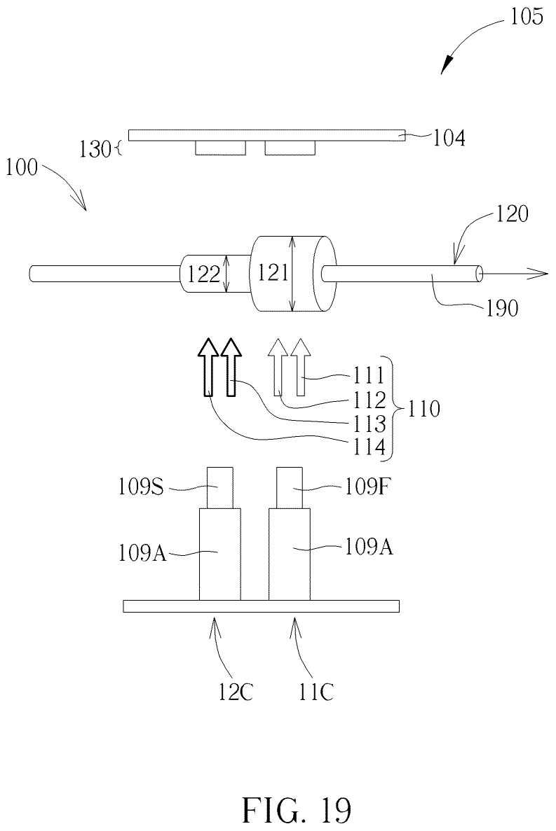

Please refer to FIG. 19 for the light detection device 105 for use in this embodiment. The light detection device 105 shown in FIG. 19 is similar to what is illustrated in FIG. 15. The major difference between the two is that EMBODIMENT 5 includes a group of rays 110 which has the first beam 111, the second beam 112, the third beam 113 and the fourth beam 114 respectively from two individual light sources, namely a light source 109F and a light source 109S to emit four rays 110 with four peak wavelengths and with four wavelength ranges. There are a first beam path 121 corresponding to the first beam 111, the first beam path 121 corresponding to the second beam 112, a second beam path 122 corresponding to the third beam 113, and the second beam path 122 corresponding to the fourth beam 114 in the variable dimension space 120. Please refer to EMBODIMENT 3 for the details of other elements.

A GaN laser with a peak emission wavelength of 458 nm and a GaN laser with a peak emission wavelength of 530 nm are respectively used to measure the absorption spectrum of a copper sulfate aqueous solution of 1000 ppm. Based on the optical data obtained in EMBODIMENT 4, it is known that a shorter beam path is better for a peak emission wavelength of 460 nm.

First, the chambers 1 and 2 in the variable dimension space 120 are empty to make sure there is no liquid in the variable dimension space 120. Second, the light source 109F is placed at the first location 11C and emits a first beam 111 with an electric current of 100 mA. The first beam 111 is received by the detector set 130 to measure a signal B5-empty via a first beam path 121. Third, the light source 109F is placed at the first location 11C and emits a second beam 112 with an electric current of 200 mA. The second beam 112 is received by the detector set 130 to measure a signal B6-empty via the first beam path 121. Fourth, the light source 109S is placed at the second location 12C and emits a third beam 113 with an electric current of 100 mA. The third beam 113 is received by the detector set 130 to measure a signal A11-empty via a second beam path 122 which is shorter than the first beam path 121. Fifth, the light source 109S is placed at the second location 12C and emits a fourth beam 114 with an electric current of 200 mA. The fourth beam 114 is received by the detector set 130 to measure a signal A12-empty via the second beam path 122.

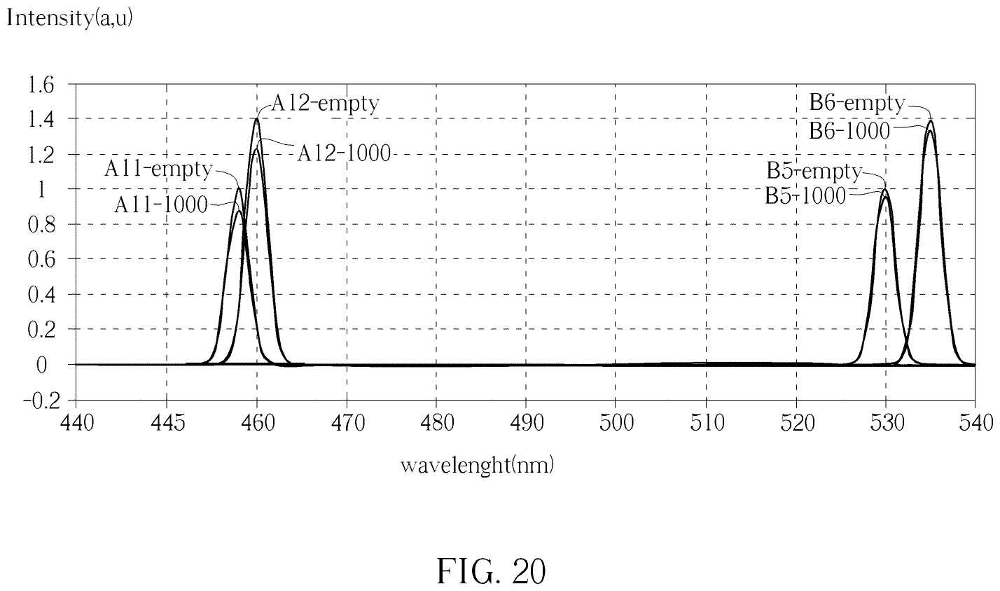

Sixth, the copper sulfate aqueous solution of 1000 ppm is injected into the chambers 1 and 2 in the variable dimension space 120 to serve as the fluid 190. Seventh, the light source 109F is placed at the first location 11C and emits the first beam 111 with an electric current of 100 mA. The first beam 111 is received by the detector set 130 to measure a signal B5-1000 via the first beam path 121. Eighth, the light source 109S is placed at the first location 11C and emits the second beam 112 with an electric current of 200 mA. The second beam 112 is received by the detector set 130 to measure a signal B6-1000 via the first beam path 121. Ninth, the light source 109S is placed at the second location 12C and emits the third beam 113 with an electric current of 100 mA. The third beam 113 is received by the detector set 130 to measure a signal A11-1000 via the second beam path 122. Tenth, the light source 109S is placed at the second location 12C and emits the fourth beam 114 with an electric current of 200 mA. The fourth beam 114 is received by the detector set 130 to measure a signal A12-1000 via the second beam path 122. The absorption spectrum of the above 8 signals of the copper sulfate aqueous solution of 1000 ppm is shown in FIG. 20.

The above measurements are respectively repeated 3 times to calculate the Dvs of the transmittance of the two wavelengths. The optical data and the resultant Dv for the peak wavelengths of 458 nm and 530 nm with an electric current of 100 mA or of 200 mA with a standard beam path or a shorter beam path after 5 measurements are respectively shown in Table 8.

TABLE 8

| peak wavelengths | 458 | 458 | 530 | 530 |
|---|---|---|---|---|
| beam paths | short | short | standard | standard |
| electric current | 100 mA | 200 mA | 100 mA | 200 mA |
| transmittance-1 | 87.200% | 88.085% | 96.228% | 95.800% |
| transmittance-2 | 87.500% | 88.063% | 95.742% | 95.700% |
| transmittance-3 | 87.600% | 87.971% | 95.653% | 96.200% |
| Avg | 87.400% | 88.000% | 95.900% | 95.900% |
| Deviation Value (Dv) | 0.457% | 0.130% | 0.600% | 0.521% |

It is observed from Table 8 that, the intensities of the light sources 109F and 109S may be adjusted so that they are close to each other by the adjustment of the beam paths to result in similar signal-to-noise ratios because it is known that a shorter beam path is better for a peak emission wavelength of 458 nm.

### Embodiment 6

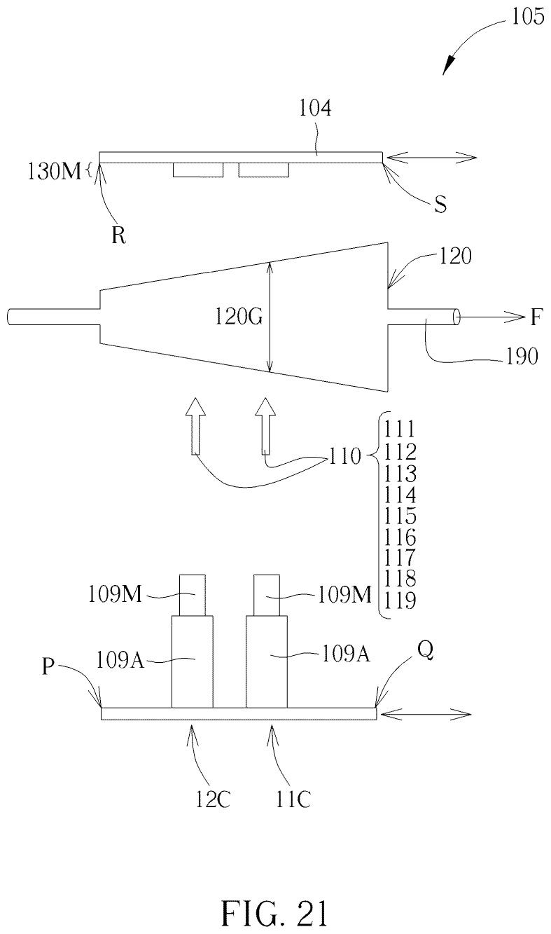

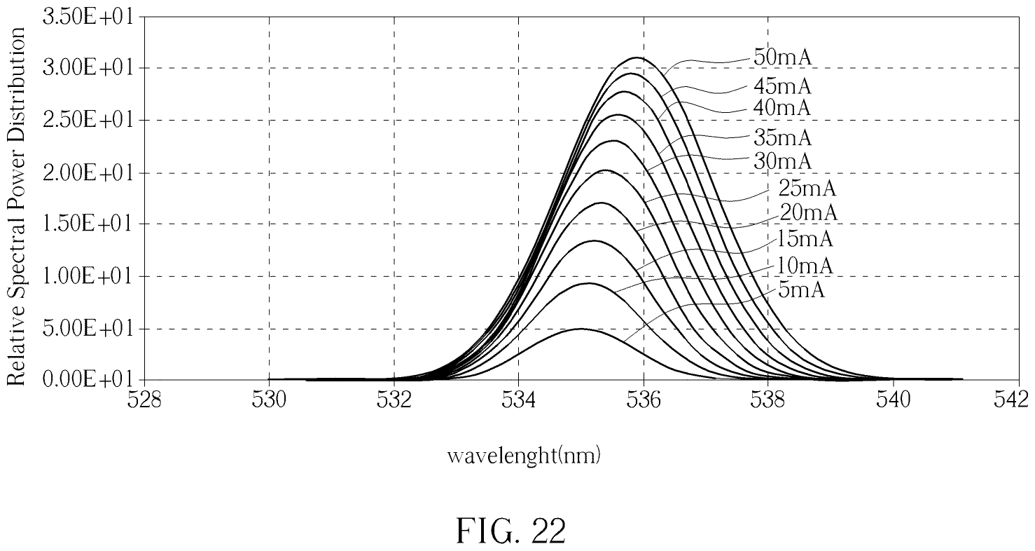

Please refer to FIG. 21 for the light detection device 105 for use in this embodiment. The light detection device 105 shown in FIG. 22 is similar to what is illustrated in FIG. 15. The major difference between the two is that EMBODIMENT 6 includes a movable light source 109M and a movable detector set 130M which are respectively and individually movable relative to the variable dimension space 120.

In other words, the light detection device 105 for use in this embodiment has least the following structural and mechanical features:
1. The light source 109M is movable relative to the variable dimension space 120, and moreover the light source 109M is able to scan between the two locations P and Q corresponding to the two dimensional limits of the variable dimension space 120 to enable the above mentioned scan concept;
2. the detector set 130M is movable relative to the variable dimension space 120, and moreover the detector set 130M is able to scan between the two locations R and S corresponding to the two dimensional limits of the variable dimension space 120 to enable the above mentioned scan concept;
3. the variable dimension space 120 has a gradient path dimension 120G;
4. one single light source 109M provides unlimited peak wavelength by adjusting the driving electric current;
5. it is possible to accommodate multiple light sources 109M;
6. it is possible to accommodate multiple detector sets 130M;
7. it is possible to adjust the peak wavelengths and the wavelength ranges of the beams, such as but not limited to, the first beam 111, the second beam 112, the third beam 113, the fourth beam 114, the fifth beam 115, the sixth beam 116, the seventh beam 117, the eighth beam 118, the ninth beam 119, emitted by one single light source 109M; and
8. it is possible to test a variety of liquids by using the light detection device 105 in this embodiment. Please refer to EMBODIMENT 3 for the details of other elements.

As shown in the above mechanism, the design of a gradient beam path may go with a fixed light source and with a fixed detector set, or alternatively the light source 109M and/or the detector set 130M is movable relative to the variable dimension space 120 to enable another possible way of a gradient beam path.

Or alternatively, the movable light source 109M to combine with the movable detector set 130M, and/or the adjustment of the wavelength of light emission by adjusting the driving electric current is able to create countless measurement points or counts as shown in FIG. 13 to enable the above mentioned scan concept, such as the purpose of stepless gradual change of beam paths plus stepless change of wavelengths.

This design is suitable for the detection requirements of high wavelength resolution. By changing the driving conditions, the wavelength resolution may be reduced to less than 0.01 nm.

### Embodiment 7

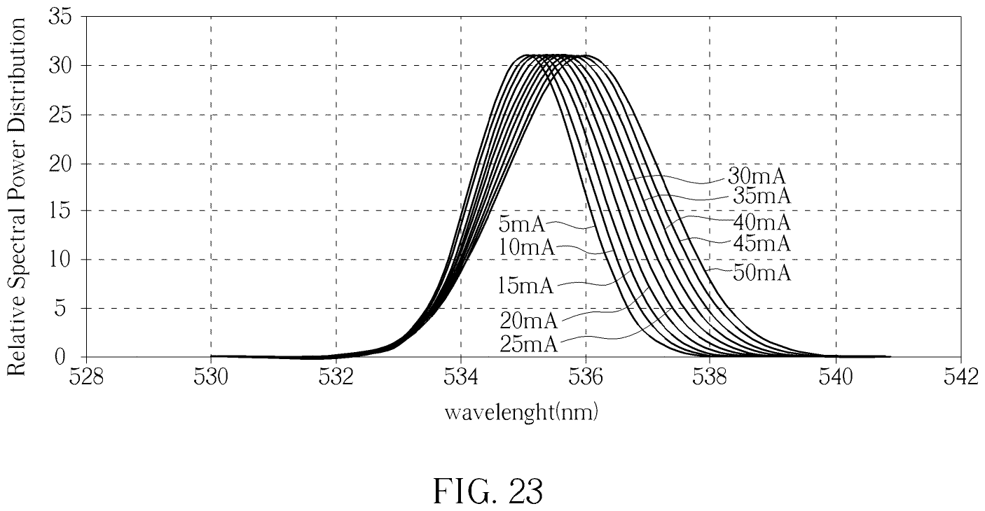

Please refer to FIG. 22 or to FIG. 23 for the scan mode for use in the present invention. FIG. 22 illustrates an example of emission spectra of a 535 nm laser at an interval with 5 mA between the 5˜50 mA driving electric currents. FIG. 23 illustrates an example of emission spectra by different hardware amplification of a 535 nm laser at an interval with 5 mA between the 5˜50 mA driving electric currents. Software amplification or different beam paths may achieve similar efficacy.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light-emitting device, comprising:
a group of rays comprising a first beam of a first wavelength range and of a first peak wavelength as well as a second beam of a second wavelength range and of a second peak wavelength, wherein the first peak wavelength is different from the second peak wavelength;
a detector set to detect the group of rays; and
a variable dimension space disposed between the group of rays and the detector set and comprising a first beam path of a first length for the first beam to pass through and a second beam path of a second length for the second beam to pass through, wherein the first length is different from the second length.

2. The light-emitting device according to claim 1, wherein the group of rays is provided by one single light-emitting element.

3. The light-emitting device according to claim 2, wherein the first wavelength range and the second wavelength range are adjusted by adjusting an electric current of the one single light-emitting element so that the first wavelength range is different from the second wavelength range.

4. The light-emitting device according to claim 2, wherein the first peak wavelength and the second peak wavelength are adjusted by adjusting an electric current of the one single light-emitting element so that the first peak wavelength is different from the second peak wavelength.

5. The light-emitting device according to claim 2, wherein the first wavelength range and the second wavelength range are adjusted by adjusting a temperature of the one single light-emitting element so that the first wavelength range is different from the second wavelength range.

6. The light-emitting device according to claim 2, wherein the first peak wavelength and the second peak wavelength are adjusted by adjusting a temperature of the one single light-emitting element so that the first peak wavelength is different from the second peak wavelength.

7. The light-emitting device according to claim 2, wherein the group of rays further comprises a third beam of a third wavelength range and a third peak wavelength, wherein the third wavelength range is different from the first wavelength range and from the second wavelength range as well as the third peak wavelength is different from the first peak wavelength and from the second peak wavelength.

8. The light-emitting device according to claim 7, wherein the third wavelength range is adjusted by adjusting an electric current of the one single light-emitting element.

9. The light-emitting device according to claim 7, wherein the third peak wavelength is adjusted by adjusting an electric current of the one single light-emitting element.

10. The light-emitting device according to claim 7, wherein the third wavelength range is adjusted by adjusting a temperature of the one single light-emitting element.

11. The light-emitting device according to claim 7, wherein the third peak wavelength is adjusted by adjusting a temperature of the one single light-emitting element.

12. The light-emitting device according to claim 2, wherein the one single light-emitting element is a light-emitting diode, a vertical cavity surface-emitting laser, or a laser diode.

13. The light-emitting device according to claim 1, wherein the group of rays is provided by a plurality of light-emitting elements.

14. A light detection device, comprising:
a light source controller;
a group of rays controlled by the light source controller and comprising a first beam of a first wavelength range and of a first peak wavelength as well as a second beam of a second wavelength range and of a second peak wavelength, wherein the first peak wavelength is different from the second peak wavelength;
a detector set to receive the group of rays;
a variable dimension space disposed between the group of rays and the detector set and comprising a first beam path of a first length for the first beam to pass through and a second beam path of a second length for the second beam to pass through, wherein the first length is different from the second length, and the first beam and the second beam respectively pass through a fluid; and
a calculator electrically connected to the detector set.

15. The light detection device according to claim 14, wherein the group of rays is provided by one single light-emitting element.

16. The light detection device according to claim 15, wherein the first wavelength range and the second wavelength range are adjusted by the light source controller to adjust an electric current of the one single light-emitting element so that the first wavelength range is different from the second wavelength range.

17. The light detection device according to claim 15, wherein the first peak wavelength and the second peak wavelength are adjusted by the light source controller to adjust an electric current of the one single light-emitting element so that the first peak wavelength is different from the second peak wavelength.

18. The light detection device according to claim 15, wherein the first wavelength range and the second wavelength range are adjusted by the light source controller to adjust a temperature of the one single light-emitting element so that the first wavelength range is different from the second wavelength range.

19. The light detection device according to claim 15, wherein the first peak wavelength and the second peak wavelength are adjusted by the light source controller to adjust a temperature of the one single light-emitting element so that the first peak wavelength is different from the second peak wavelength.

20. The light detection device according to claim 15, wherein the calculator correspondingly generates a first detection signal and a second detection signal according to the first beam and to the second beam, wherein a first signal-to-noise ratio of the first detection signal is greater than a second signal-to-noise ratio of the second detection signal.

21. The light detection device according to claim 15, wherein the group of rays further comprises a third beam of a third wavelength range and of a third peak wavelength, wherein the third wavelength range is different from the first wavelength range and from the second wavelength range as well as the third peak wavelength is different from the first peak wavelength and from the second peak wavelength.

22. The light detection device according to claim 21, wherein the third wavelength range is adjusted by the light source controller to adjust an electric current of the one single light-emitting element.

23. The light detection device according to claim 21, wherein the third peak wavelength is adjusted by the light source controller to adjust an electric current of the one single light-emitting element.

24. The light detection device according to claim 21, wherein the third wavelength range is adjusted by the light source controller to adjust a temperature of the one single light-emitting element.

25. The light detection device according to claim 21, wherein the third peak wavelength is adjusted by the light source controller to adjust a temperature of the one single light-emitting element.

26. The light detection device according to claim 21, wherein the calculator correspondingly generate a third detection signal according to the third beam, wherein a third signal-to-noise ratio of the third detection signal is greater than the second signal-to-noise ratio of the second detection signal.

27. The light detection device according to claim 15, wherein the one single light-emitting element is a light-emitting diode, a vertical cavity surface-emitting laser, or a laser diode.

28. The light detection device according to claim 14, wherein the group of rays is provided by a plurality of light-emitting elements.

29. A method for optical analysis, comprising:
providing the light-emitting device of claim 1;
providing the first beam and the second beam to respectively pass through the variable dimension space, wherein a fluid flows through the first beam path and through the second beam path; and
receiving the first beam and the second beam by using the detector set to respectively obtain a first detection signal and a second detection signal to correspondingly generate a first analytic outcome of the fluid according to the first detection signal and to the second detection signal.

30. The method for optical analysis according to claim 29, wherein the group of rays is provided by one single light-emitting element.

31. The method for optical analysis according to claim 30, wherein the first wavelength range and the second wavelength range are adjusted by adjusting an electric current of the one single light-emitting element so that the first wavelength range is different from the second wavelength range.

32. The method for optical analysis according to claim 30, wherein the first peak wavelength and the second peak wavelength are adjusted by adjusting an electric current of the one single light-emitting element so that the first peak wavelength is different from the second peak wavelength.

33. The method for optical analysis according to claim 30, wherein the first wavelength range and the second wavelength range are adjusted by adjusting a temperature of the one single light-emitting element so that the first wavelength range is different from the second wavelength range.

34. The method for optical analysis according to claim 30, wherein the first peak wavelength and the second peak wavelength are adjusted by adjusting a temperature of the one single light-emitting element so that the first peak wavelength is different from the second peak wavelength.

35. The method for optical analysis according to claim 30, wherein the first beam path and the second beam path are adjusted by adjusting a positional parameter of the one single light-emitting element.

36. The method for optical analysis according to claim 30, wherein a variable dimension of the variable dimension space is continuous.

37. The method for optical analysis according to claim 30, wherein a variable dimension of the variable dimension space is discontinuous.

38. The method for optical analysis according to claim 29, wherein a first signal-to-noise ratio of the first detection signal is greater than a second signal-to-noise ratio of the second detection signal.

39. The method for optical analysis according to claim 38, wherein the group of rays further comprises a third beam of a third wavelength range and of a third peak wavelength, wherein the third wavelength range is different from the first wavelength range and from the second wavelength range as well as the third peak wavelength is different from the first peak wavelength and from the second peak wavelength.

40. The method for optical analysis according to claim 39, wherein the third wavelength range is adjusted by adjusting an electric current of the one single light-emitting element.

41. The method for optical analysis according to claim 39, wherein the third peak wavelength is adjusted by adjusting an electric current of the one single light-emitting element.

42. The method for optical analysis according to claim 39, wherein the third wavelength range is adjusted by adjusting a temperature of the one single light-emitting element.

43. The method for optical analysis according to claim 39, wherein the third peak wavelength is adjusted by adjusting a temperature of the one single light-emitting element.

44. The method for optical analysis according to claim 39, wherein the variable dimension space further comprises a third beam path of a third length for the third beam to pass through and the fluid flows through the third beam path.

45. The method for optical analysis according to claim 44, wherein the third beam path is adjusted by adjusting a positional parameter of the one single light-emitting element.

46. The method for optical analysis according to claim 39, wherein the third beam is received by the detector set to obtain a third detection signal for the calculator to correspondingly generate a third signal-to-noise ratio of the third detection signal according to the third detection signal, and the third signal-to-noise ratio of the third detection signal is greater than the second signal-to-noise ratio of the second detection signal.

47. The method for optical analysis according to claim 29, wherein the one single light-emitting element is a light-emitting diode, a vertical cavity surface-emitting laser, or a laser diode.

48. The method for optical analysis according to claim 29, wherein the group of rays is provided by a plurality of light-emitting elements.
